(19) United States
(12) Patent Application Publication
(10) Pub. No.: US 2009/0031781 A1
(43) Pub. Date: Feb. 5, 2009

(54) Scale with Gravity Calibration Feature

(75) Inventor: Nigel G. Mills, Kettering, OH (US)

Correspondence Address: THOMPSON HINE LLP;Intellectual Property Group, P.O Box 8801, DAYTON, OH, 45401-8801, US

(73) Assignee: Premark FEG L.L.C., Wilmington, DE (US)

(21) Appl. No.: 11/831,334

(22) Filed: Jul. 31, 2007

(51) Int. Cl. G01G 23/01

(52) U.S. Cl. 73/1.13; 702/101

(57) ABSTRACT

A scale includes a self-calibration feature that enables the scale to automatically determine an appropriate gravity strength value for an operating location of the scale.

### TECHNICAL FIELD

The present application relates generally to scales used to weigh items, and more particularly to a scale that includes a self-calibration operation that takes into account gravity strength at a location of scale operation.

### BACKGROUND

Scales have been used in stores such as supermarkets and groceries to weigh and price food items and to generate a pricing label for such food items. Applicable regulations require a level of precision in such scales that can be defeated by differences in gravity strength depending upon scale location. Accordingly, it would be desirable to provide a scale including a self-calibration operation to determine the gravity strength applicable to a location of scale operation.

### SUMMARY

In one aspect, a method of scale calibration involves: (a) identifying to the scale an operating location for the scale; (b) the scale identifying a gravity value corresponding the operating location; and (c) the scale associating the identifying gravity value into a weighing algorithm stored in memory of the scale. In one implementation of such a method, step (a) involves identifying address information to the scale and step (b) involves (i) accessing a coordinates database that provides latitude and longitude information corresponding to the address information and (ii) using the latitude and longitude information to calculate the gravity strength value or retrieve the gravity strength value from a database.

In another aspect, a scale incorporating a self-calibrating feature includes a weighing station for receiving items to be weighed, the weighing station including a load cell for outputting a weight indicative signal. An input device is provided. A controller is operatively connected with the input device and the load cell, the controller including associated memory storing at least one weighing algorithm. The controller includes a calibration mode in which it operates such that upon input of a scale location via the input device, the controller automatically determines a gravity strength value corresponding to the scale location, and the controller stores the gravity strength value in its memory in association with the weighing algorithm.

### BRIEF DESCRIPTION OF THE DRAWINGS

FIG. 1 is a perspective view of an exemplary food product scale;

FIG. 2 is a schematic view of the scale of FIG. 1;

FIG. 3 is a flow diagram of an embodiment of a calibration method.

### DETAILED DESCRIPTION

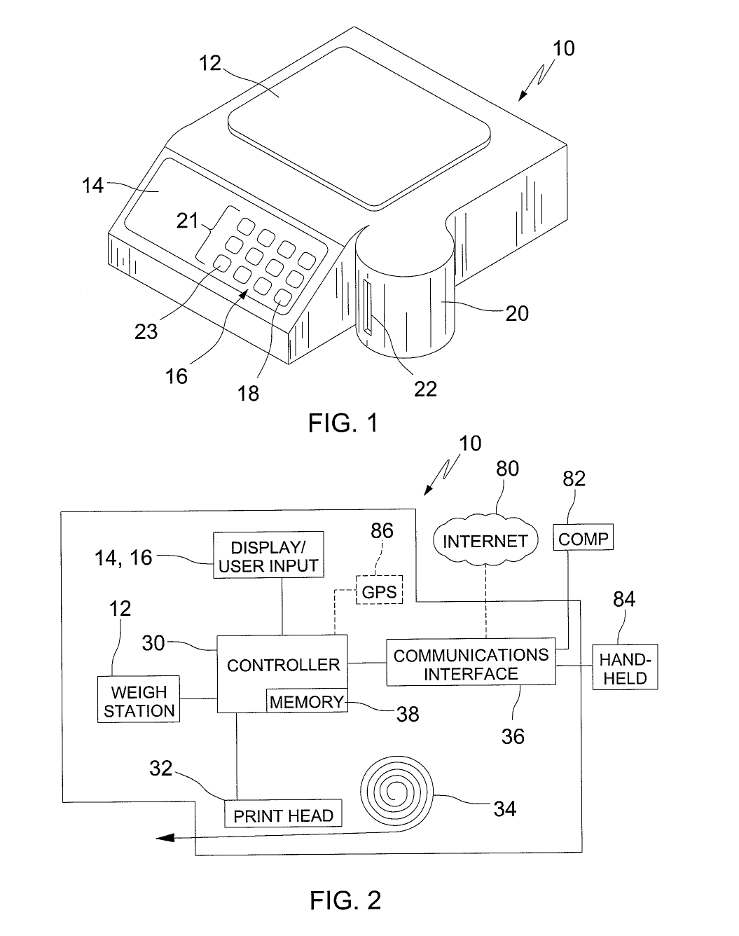

Referring to FIG. 1 an exemplary scale 10 is shown including a weigh station 12 and a display 14. Weigh station 12 may take the form of a platter-type member supported in relationship to a load cell (internal of the scale housing) that produces a weight indicative signal when a food item is placed on the weigh station 12 for weighing. Illustrated display 14 may take the form of an LCD-type display, but other technologies could be used. In the illustrated embodiment the display 14 is a touch screen-type display that also functions as a user input device 16 by displaying buttons/icons 18 that can be triggered by a user. A separate user input device could also be provided, for example, in the form of manually activated keys/buttons located alongside the display 14. A side portion 20 of the scale housing holds a label printer and associated supply of labels, which are dispensed through a label slot 22 in the housing. Although display screen 14 is shown incorporated into the housing of the scale 10, the display could take the form of a marquee-type display located on a support extending upward from the scale housing.

Referring now to FIG. 2, an exemplary schematic of the scale 10 is shown. The scale includes a controller 30, such as a microprocessor based unit, connected to control the display 14 and user input 16 and connected to receive weight indicative signals from the weighing station 12. A print head 32 and associated supply of label stock 34 that can be moved past the print head 32 is also shown. In one example the print head 32 may be a thermal print head for use with thermally activated label stock. However, other types of printing technologies and label media could also be used. The controller 30 is also connected with a communications interface 36, which may take the form of a standard connector (and associated circuitry) for a USB, RS-232, Ethernet or other hard-wired communication line. In another example the communications interface 36 may be formed by a wireless communication device such as an RF transceiver. The illustrated controller 30 includes associated memory 38 for storing product information and programs/algorithms used during various operating modes of the scale.

A stored weighing algorithm is used to calculate weight based upon an output signal of a load cell. The weighing algorithm incorporates a gravity strength value into the calculation. The controller is configured to perform a self-calibration operation in order to determined and use an appropriate gravity strength value for a location at which the scale operates.

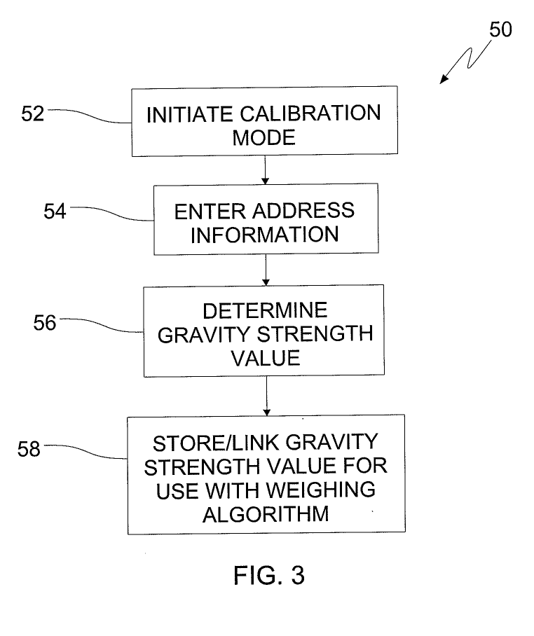

In one example, referring to the process diagram 50 of FIG. 3, an operator selects a scale set-up or calibration mode at 52. Such selection may be via the interface 14, 16. The operator is prompted to enter a full or partial address at 54 (e.g., street address and zip code, or just zip code) of the store in which the scale is located. Based upon this address the scale automatically utilizes the communications interface 36 to access a remote coordinates database that will return a latitude, longitude and altitude for the address. The coordinates database could, for example, be accessed via an Internet web site 80 (see FIG. 2). Alternatively, the coordinates database could be stored in a computer system 82 of the store. In another example, where sufficient memory is provided in the scale, the coordinates database could be stored within the scale memory 38.

The scale controller then uses the coordinates to determine the gravity strength value at 56. In one example, the controller may submit the coordinates (e.g., latitude and longitude, or latitude, longitude and altitude) to a remote computer system (e.g., at a web site) that uses the coordinates to calculate and return a gravity strength value via a gravity strength algorithm or that uses the coordinates to retrieve the gravity strength value from a gravity strength database. In another example, the scale includes the gravity strength algorithm in its memory, and internally makes the gravity strength calculation based upon the coordinates, or the scale may incorporate the gravity strength database in its memory.

The scale controller subsequently stores the obtained (e.g., calculated or retrieved from a database) gravity strength value in its memory for use in association with the weighing algorithm at 58. In this manner, any given scale can automatically determine an appropriate gravity strength value for its location based upon the input of store address information, or other store location information, simplifying scale calibration and improving scale performance.

The foregoing operations could be carried out while the scale is actually located in the store or other building (e.g., during delivery and set-up). Alternatively, where the intended scale location is known in advance the operations could be carried out before the scale is located within the store or other building (e.g., at a local distribution site or even at the manufacturing facility).

In an alternative embodiment, a hand-held unit 84 could be used to communicate store location information to the scale controller via the communications interface 36, or the store computer 82 may communicate the information to the scale controller. In another embodiment, the scale could incorporate an internal GPS module 86 that would be used to identify the store location information when triggered to do so during the set-up or calibration mode. Alternatively, the hand-held unit 84 could include the GPS module and communicate the GPS information to the controller.

It is to be clearly understood that the above description is intended by way of illustration and example only and is not intended to be taken by way of limitation. Other changes and modifications could be made.

What is claimed is:

1. A method of scale calibration, the method comprising:
(a) identifying to the scale an operating location for the scale;
(b) the scale identifying a gravity value corresponding the operating location;
(c) the scale associating the identifying gravity value into a weighing algorithm stored in memory of the scale.

2. The method of claim 1, wherein steps (a), (b) and (c) occur within a building where the scale is being installed.

3. The method of claim 1 wherein step (a) involves utilizing a user input device of the scale to enter address information of a building in which the scale is being installed.

4. The method of claim 1 wherein step (a) involves using another computer device to communicate the operating location to the scale.

5. The method of claim 1 wherein step (b) involves utilizing one of a gravity strength calculation or a gravity strength database to obtain the gravity strength value.

6. The method of claim 5 wherein step (a) involves using latitude and longitude information of the operating location to obtain the gravity strength value.

7. The method of claim 6 wherein step (a) involves identifying address information to scale and step (b) involves accessing a coordinates database that provides latitude and longitude information corresponding to the address information.

8. The method of claim 7 wherein the address information is at least zip code.

9. The method of claim 7 wherein the coordinates database provides latitude, longitude and altitude information corresponding to the address information.

10. The method of claim 7 wherein the one of the gravity strength calculation or gravity strength database is accessed remotely via a scale communications link and the coordinates database is accessed remotely via the scale communications link.

11. The method of claim 7 wherein the one of the gravity strength calculation or the gravity strength database is stored in memory of the scale and the coordinates database is stored in memory of the scale.

12. The method of claim 1 wherein step (a) involves use of GPS information to identify the operating location.

13. The method of claim 12 wherein the scale includes an internal GPS unit that defines the scale location.

14. The method of claim 12 wherein a secondary computer device contains a GPS unit, the secondary computer device communicates the GPS information to the scale via a communication link.

15. A scale incorporating a self-calibrating feature, the scale comprising:
a weighing station for receiving items to be weighed, the weighing station including a load cell for outputting a weight indicative signal;
an input device;
a controller operatively connected with the input device and the load cell, the controller including associated memory storing at least one weighing algorithm, the controller including a calibration mode in which it operates such that:
upon input of a scale location via the input device, the controller automatically determines a gravity strength value corresponding to the scale location, and the controller stores the gravity strength value in its memory in association with the weighing algorithm.

16. The scale of claim 15 wherein the input device is a user interface with input keys.

17. The scale of claim 16 wherein the user interface is a touch-sensitive screen and the input keys are presented digitally on the touch-sensitive screen.

18. The scale of claim 15 wherein the input device is communication port for receiving digital data.

19. The scale of claim 15 wherein the controller operates to access a remote coordinates database and one of a remote gravity calculation algorithm or remote gravity strength database to determine the gravity strength value.

20. The scale of claim 15 wherein the scale includes an integrated GPS unit to identify scale location.
